(19) United States
(12) Patent Application Publication
(10) Pub. No.: US 2021/0410038 A1
(43) Pub. Date: Dec. 30, 2021

(54) AUTOMATIC FAILOVER HANDLING MINIMIZATION IN WIRELESS NETWORK ENVIRONMENT

(71) Applicant: Uber Technologies, Inc., San Francisco, CA (US)

(72) Inventors: Christopher Nishanth Francis, Dublin, CA (US); Sivabalan Narayanan, Santa Clara, CA (US); Rajesh Mahindra, Newark, CA (US); Vinoth Chandar, San Jose, CA (US); Jatin Lodhia, Oakland, CA (US)

(21) Appl. No.: 17/363,585

(22) Filed: Jun. 30, 2021

Related U.S. Application Data
(60) Provisional application No. 63/046,038, filed on Jun. 30, 2020.

(51) Int. Cl. H04W 36/30; H04W 36/12; H04W 24/08; H04L 29/12

(52) U.S. Cl. CPC H04W 36/305; H04L 61/1511; H04W 24/08; H04W 36/12

(57) ABSTRACT

A mechanism is disclosed for automatically detecting whether the client device is experiencing wireless communication issues and switching communications from a first server group to second server group, if necessary. Responsive to determining that the client device is experiencing wireless communication issues, the system performs a health check against the second server group, and responsive to determining, based on the health check, that the issue is on the client device, the system refrains from failing over to the second server group. Responsive to determining that the client device is not experiencing issues, the system fails over to a second server group. When the client device determines that the first server group is available, the client device fails back to the first server group.

### CROSS-REFERENCE TO RELATED APPLICATIONS

This application claims the benefit of U.S. Provisional Patent Application No. 63/046,038, filed Jun. 30, 2020, which is hereby incorporated in its entirety by reference.

### TECHNICAL FIELD

This disclosure generally relates to service failover, and more particularly to detecting whether a device should fail-over to a different service instance.

### BACKGROUND

Service continuity in the event of a datacenter failure or another large-scale failure is extremely important in today's computing environments. Service continuity is particularly important in the context of providing transportation services to users as millions of users rely on these services. Customers demand reliable and failure free access for submitting transportation requests and transportation providers (e.g., drivers) require receiving those requests quickly as those providers move around in and out of areas where wireless connections may not be available.

### SUMMARY

Therefore, examples herein describe a mechanism, built into a client device (e.g., into a transportation application), for automatically detecting whether the client device is experiencing wireless communication issues, and switching communications from one server group (e.g., primary front-end infrastructure) to another server group (e.g., secondary front-end infrastructure). In various embodiments, a system is disclosed that is enabled to detect when wireless communications on a client device become disrupted. For example, when a transportation provider is moving (e.g., in a vehicle), the associated smart device (e.g., a smart phone or an electronic tablet) may move into and out of wireless service provider coverage areas. When the device moves out of wireless service provider coverage, the transportation application may determine that the device is no longer able to receive data from the primary transportation provider infrastructure and attempt to perform a fail over operation to a secondary transportation provider network. However, this is not desirable because the primary transportation provider infrastructure has not failed. That is, the smart device is simply not able to connect because the smart device is not in an area where wireless connectivity is available.

Thus, instead of failing over to a secondary transportation provider infrastructure (e.g., a secondary front-end infrastructure), it is desirable for the transportation application to perform different actions. For example, when the transportation application on the client device detects communication errors, it may transmit a health check to the secondary transportation provider infrastructure. Based on the response from the health check, the transportation application may determine whether the issue lies with the application itself, the client device, or the primary transportation provider infrastructure. In response to determining that the issue lies with the connection on the client device, the transportation application may continue to try and reconnect to the primary transportation provider infrastructure. However, in response to determining that the issue lies with the primary transportation provider infrastructure, the transportation application may initiate a failover to the secondary transportation provider infrastructure.

The transportation application may be designed with a finite state machine to ensure that the traffic sent is maximized.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG.) 1 illustrates a system for automatically detecting whether the client device is experiencing wireless communication issues and switching communications from one server group to another server group, in accordance with some embodiments of the current disclosure.

FIG. 2 illustrates one embodiment of exemplary modules for automatically detecting whether the client device is experiencing wireless communication issues and switching communications from one server group to another server group, in accordance with some embodiments of the current disclosure.

FIG. 3 is a block diagram illustrating components of an example machine able to read instructions from a machine-readable medium and execute them in a processor (or controller), in accordance with some embodiments of this disclosure.

FIG. 4 illustrates one embodiment of an exemplary flow chart for automatically detecting whether the client device is experiencing wireless communication issues and switching communications from one server group to another server group, in accordance with some embodiments of the current disclosure.

### DETAILED DESCRIPTION

The Figures (FIGs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

In various embodiments, a system is disclosed that is enabled to detect when wireless communications on a client device have become disrupted. In some embodiments, wireless communications disruptions may include any network communication disruption on a client device (e.g., loss of signal, user placing the device in airplane mode, or another suitable communication disruption). The system may detect a disruption based on receiving a threshold number (e.g., five) of errors (e.g., timeouts or other network errors) for a first server group (e.g., a primary front-end infrastructure) in a threshold amount time. In response, the system may perform a connectivity health check to determine whether the client device is experiencing a wireless communications issue. The system may wirelessly transmit a first health check message to a second server group (i.e., a secondary front-end infrastructure). The system may wait for a time out period to expire before evaluating the results of the first health check message. In response to determining that the system received a response to the first health check message, the system may determine that there are no wireless communications interruptions on the client device. Based on determining that the client device is not experiencing a wireless communications interruption, the system may switch wireless communications to the second server group (e.g., secondary front-end infrastructure). However, if the system does not receive a response to the health check message, the system may determine that the client device is experiencing a communication interruption and refrain from switching wireless communications to the second server group. Instead the system may wait for a predetermined amount of time before attempting to resume communications with the first server group. The disclosed mechanism enables a client device to identify when it is having communication issues. As a result, fail over to a secondary group of servers is prevented and when wireless communications are restored on the client device, the device may continue to communicate with the primary group of servers.

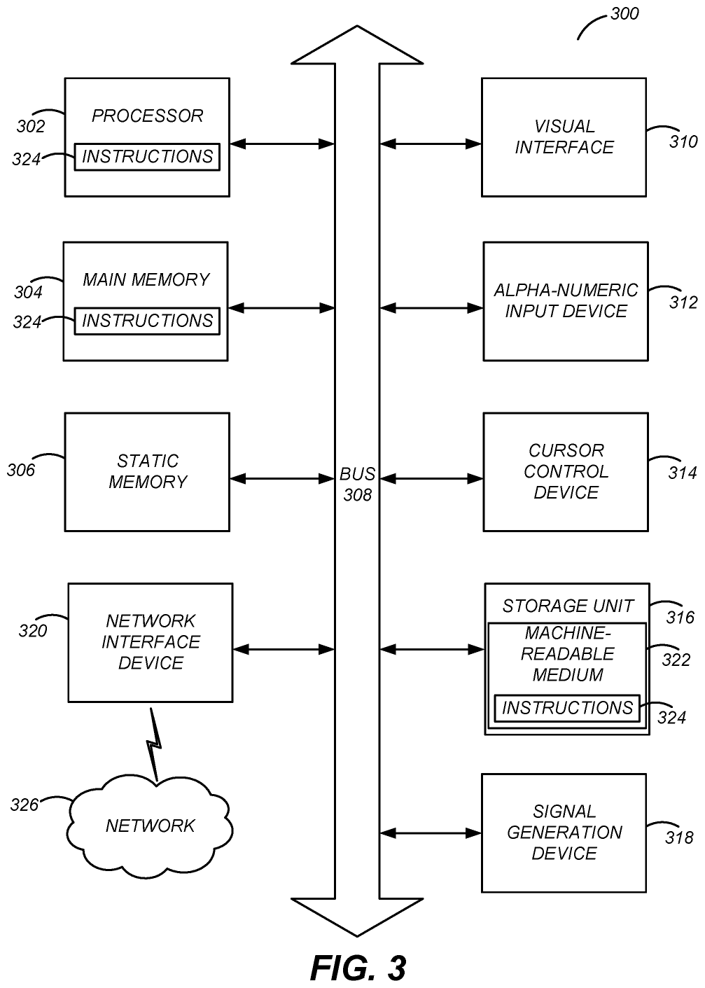

FIG. 1 illustrates system 100 for automatically detecting whether the client device 125 is experiencing wireless communication issues and switching communications from one server group to another server group. System 100 may include two separate front-end infrastructures (e.g., primary front-end infrastructure 110 and secondary front-end infrastructure 120). Each infrastructure may include one or more servers (e.g., servers with one or more components described in FIG. 3). Each front-end infrastructure may provide connectivity to client devices and proxy client communications (e.g., transportation requests, transportation responses) to back-end infrastructure 130. Back-end infrastructure 130 may include one or more servers from processing transportation requests and responses. For example, back-end infrastructure 130 may receive requests for transportation from client devices and transmit those requests to transportation providers who may in turn accept those requests.

Although described herein with reference to transportation requests and respective transportation responses, the described techniques may be employed with alternative service requests and respective service responses, such as service requests from alternative applications upon a client device 125.

Each front-end infrastructure may include front-end proxy servers that terminate secure Transport Layer Security (“TLS”) connections over Transmission Control Protocol and/or Quick User Datagram Protocol Internet Connections from mobile applications. Traffic (e.g., Hypertext Transfer Protocol Secure (“HTTPS”)) originating from mobile application over these connections may be forwarded to backend services in a datacenter (e.g., a nearest datacenter) using existing connection pools. Edge infrastructure may span across public cloud and privately managed infrastructures. It should be noted that, if application requests are always routed to the cloud, there is a significant risk of service interruptions during both local- and global-level disruptions. Such connectivity issues can be attributed to various components of the public clouds or the intermediate Internet Service Providers, such as the Domain Name System (“DNS”) service, load balancers, inter-connects etc. The front-end infrastructures hosted in the cloud and datacenters may be registered as different domain names. By selecting the most appropriate domain-name, the mobile applications may route requests either through the cloud regions or directly to the datacenter.

The requests may be received through network 115, which may be any network that enables devices to connect to each other. For example, network 115 may be the Internet, a local network, or a combination of the two. Network 115 may support various protocols to connect devices. For example, network 115 may support an Internet Protocol (IP) that enables connections between devices using IP addresses. The IP protocol is generally used in combination with a Transmission Control Protocol (TCP) which is a set of protocols enabling devices to connect to each other. Together TCP and IP are often referred to as TCP/IP. Network 115 may include both wired and wireless segments.

System 100 may also include one or more client devices 125. Each client device may be a smart phone, electronic tablet, or another suitable device. Each client device 125 may include a corresponding transportation application 140. Transportation application 140 may include functionality to request transportation services and/or accept transportation services request. Transportation application 140 may receive user input detailing a transportation request and transmit that request to primary front-end infrastructure 110 or to secondary front-end infrastructure 120 (e.g., when primary front-end infrastructure 110 is unavailable). The transportation application 140 may also have transportation service provider features, e.g., for receiving and enabling for input representing whether the transportation provider accepts/rejects the request. In some embodiments, the transportation application 140 may be two applications; one for enabling users to input transportation requests and another for accepting/rejecting those requests by the service provider (e.g., a driver).

The described functionality (“failover handler”) may reside within the mobile networking stack as an interceptor placed above the core HTTP2/QUIC layers (i.e., an application layer and/or a transport layer of a networking stack of the client device). As HTTPS requests are generated from the application, they pass through the failover handler, that rewrites the domain-name (or host-name) before they are processed by the core HTTP library. This mechanism enables HTTPS traffic to be dynamically routed to the appropriate edge servers. Asynchronously, the failover handler continuously monitors the health of the domains and switches the domain if required based on the errors received from the HTTPS responses. In general, the failover handler may reside at the networking stack of the client device.

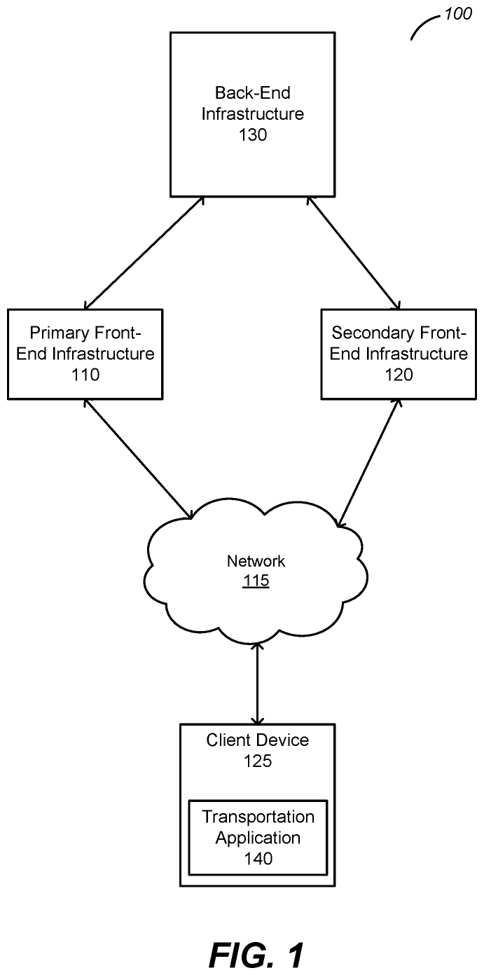

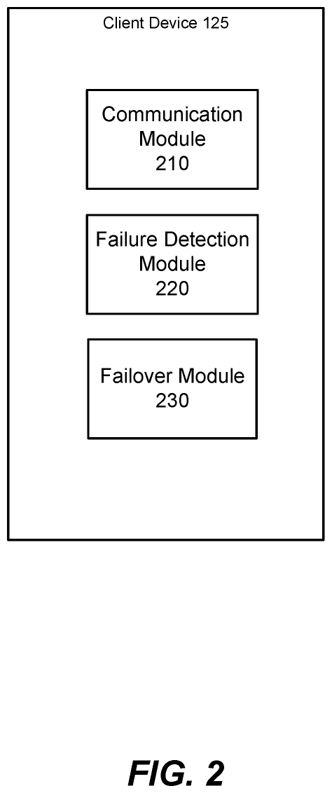

FIG. 2 illustrates one embodiment of exemplary modules for automatically detecting whether the client device is experiencing wireless communication issues and switching communications from one server group to another server group, when necessary. Client device 125, as illustrated in FIG. 2, may include communication module 210, failure detection module 220, and failover module 230. These modules may be built into transportation application 140.

Communication module 210 may wirelessly transmit one or more transportation requests from an application (e.g., transportation application) on a client device to a first server group (e.g., primary front-end infrastructure 110). The communication module 210 may also, when residing on a device associated with a transportation provider (e.g., a driver) wirelessly receive one or more transportation requests, enable a user to accept or reject these requests, and transmit the acceptance or rejection to the first server group (e.g., primary front-end infrastructure 110). Communication module 210 may include other functionality. For example, the communication module may include error detection functions and/or classes. Thus, responsive to the transmission of a transportation request, communication module 210 may receive one or more errors. Communication module 210 may use those functions to detect errors and send the errors with related information (e.g., timestamp) to failure detection module 220.

Failure detection module 220 may analyze the received error information and determine whether the error information indicates connectivity issues. For example, failure detection module 220 may determine whether a threshold number of errors were received in a threshold time period, such as ten seconds. Failure detection module 220 may identify connectivity issues using different methods (e.g., based on the type of errors received). In response to detecting connectivity issues (e.g., a threshold number of errors in the threshold time period) in the wireless communications between the client device and the first server group, failure detection module 220 may wirelessly transmit a first health check message from the client device to a second server group (e.g., to secondary front-end infrastructure 120). Based on a result of wirelessly transmitting the first health check message from the client device to the second server group, the failure detection module determines whether the client device is experiencing a wireless communications interruption.

Failure detection module 220 may determine that the client device is not experiencing a wireless communications interruption. For example, the failure detection module may receive, in response to the first health check, data from the second server group (e.g., secondary front-end infrastructure 120) indicating that the first health check was successful. Based on the successful first health check, the failure detection module may send an indication to failover module 230 of a successful first health check and data indicating an issue with the first group of servers (e.g., primary front-end infrastructure). In some embodiments, failure detection module 220 may send a command to failover module 230 to fail over communications to the second server group (e.g., secondary front-end infrastructure 120).

In some instances, the first health check may be unsuccessful e.g., because the client device is in an area where wireless connectivity is unavailable. In these instances, failure detection module 220 refrains from switching the wireless communications from the first server group to the second server group. For example, failure detection module 220 may refrain from transmitting any error information or commands to failover module 230. In some embodiments, failure detection module 220 transmits all error information and first health check results to failover module 230, and the failover module 230 determine whether to perform the fail over operation.

Failure detection module 220 may also detect when the first server group is back online and/or available. In some embodiments, when the failure detection module detects that the first server group is back online and/or available, the failure detection module may instruct failover module 230 to switch wireless communications back to the first server group. For example, the first server group may be a primary server group with a greater amount of resources (e.g., more servers, more processing power, more memory and/or other suitable resources).

In some embodiments, the environment may include more than two server groups (e.g., n server groups). Each server group may include a failover priority (e.g., based on amount of resources). The failure detection module may failover/back to an appropriate server group in order of a priority assigned to each server group. Each server group may be assigned a priority based on the amount of resources in the server group.

Failover module 230 may switch the wireless communications from the first server group (e.g., primary front-end infrastructure 110) to the second server group (e.g., secondary front-end infrastructure 120). In some embodiments, failover module 230 may receive error information and health check results and determine whether a failover should be performed. For example, in response to a health check, each server in the chain may transmit a response with specific codes to indicate whether a health check is successful or if a particular server cannot be reached and the request will time out. Based on the information, failover module 230 may determine that a particular server in the chain is not reachable and determine whether there is an issue on the client device or at a specific server (e.g., at primary front-end infrastructure 110, secondary front-end infrastructure 120, and/or back-end infrastructure 130). Based on the determination, failover module 230 may fail over the client's connection or refrain from failing over. For example, if the first health check fails at a first hop (e.g., a first server in the path), failover module 230 may determine that the client device is having communications issues and refrain from failing over. However, if the first health check fails at a further hop, failover module 230 may determine that the issue is not at the client device and execute a fail over to the second group of servers (e.g., secondary front-end infrastructure). A health check may include one or more requests to appropriate server(s).

In some embodiments, failure detection module 220 may, subsequently to failover module 230 switching the wireless communications to the second server group and while the second server group is available, transmit a second health check message to the first server group. For example, the second health check may be similar to the first health check. Based on a result of transmitting the second health check to the first server group, failure detection module 220 may determine whether the first server group is available. For example, failure detection module 220 may continue transmitting health checks to the primary front-end infrastructure with a specific frequency until the primary front-end infrastructure is available (e.g., connectivity issues are fixed). Based on determining that the first server group is available, failure detection module 220 may send a command to failover module 230 to switch the wireless communications from the second server group to the first server group. Failover module 230 may, in response to the command, switch the wireless communications from the second server group to the first server group.

In some embodiments, failure detection module 220 may determine, after a time out period, whether the client device has received, from the second group of servers, a response to the first health check message. That is, failure detection module 220 may transmit a health check and wait for a threshold amount of time to receive a response. Based on determining that the client device has not received the response to the health check message from the second group of servers, failure detection module 220 may determine that the client device is experiencing a wireless communications interruption. That is, if there is no response from the second group of servers (e.g., secondary front-end infrastructure 120) and connectivity to the first group of servers has failed, the connection issues are more likely to be on the client device, and thus, failure detection module 220 may determine that the client device is having communication issues.

In some embodiments, responses to a health check (e.g., the first health check and/or the second health check) may include codes indicating health of the transportation service on the servers in the path of the health check. Failure detection module 220 may retrieve one or more response codes from the response to the first health check message and determine, based on the one or more response codes, whether the client device is experiencing a wireless communications interruption. That is, the client device may store a table indicating a meaning of each response code. Based on the meaning of each response code, the client device may determine where a communication issue has been found. A person skilled in the art would understand that more or less modules may be used to describe the functions above. In some embodiments, additional modules may be added to client device 125 and one or more of the modules may be removed.

### Computing Machine Architecture

FIG. 3 is a block diagram illustrating components of an example machine able to read instructions from a machine-readable medium and execute them in a processor (or controller). Specifically, FIG. 3 shows a diagrammatic representation of a machine in the example form of a computer system 300 within which program code (e.g., software) for causing the machine to perform any one or more of the methodologies discussed herein may be executed. The program code may be comprised of instructions 324 executable by one or more processors 302. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 324 (sequential or otherwise) that specify actions to be taken by that machine. Further, while only a single machine is illustrated, the term “machine” shall also be taken to include any collection of machines that individually or jointly execute instructions 324 to perform any one or more of the methodologies discussed herein.

The example computer system 300 includes a processor 302 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 304, and a static memory 306, which are configured to communicate with each other via a bus 308. The computer system 300 may further include visual display interface 310. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 310 may include or may interface with a touch enabled screen. The computer system 300 may also include alphanumeric input device 312 (e.g., a keyboard or touch screen keyboard), a cursor control device 314 (e.g., a mouse, a trackball, a joystick, a motion sensor, or other pointing instrument), a storage unit 316, a signal generation device 318 (e.g., a speaker), and a network interface device 320, which also are configured to communicate via the bus 308.

The storage unit 316 includes a machine-readable medium 322 on which is stored instructions 324 (e.g., software) embodying any one or more of the methodologies or functions described herein. The instructions 324 (e.g., software) may also reside, completely or at least partially, within the main memory 304 or within the processor 302 (e.g., within a processor's cache memory) during execution thereof by the computer system 300, the main memory 304 and the processor 302 also constituting machine-readable media. The instructions 324 (e.g., software) may be transmitted or received over a network 326 via the network interface device 320.

While machine-readable medium 322 is shown in an example embodiment to be a single medium, the term “machine-readable medium” should be taken to include a single medium or multiple media (e.g., a centralized or distributed database, or associated caches and servers) able to store instructions (e.g., instructions 324). The term “machine-readable medium” shall also be taken to include any medium that is capable of storing instructions (e.g., instructions 324) for execution by the machine and that cause the machine to perform any one or more of the methodologies disclosed herein. The term “machine-readable medium” includes, but not be limited to, data repositories in the form of solid-state memories, optical media, and magnetic media.

The computer system 300 may execute (e.g., using hardware such as a processor(s), memory, and other suitable hardware) instructions associated with the modules and components described in FIG. 2 (e.g., communication module 210, failure detection module 220, and failover module 230).

### Processes

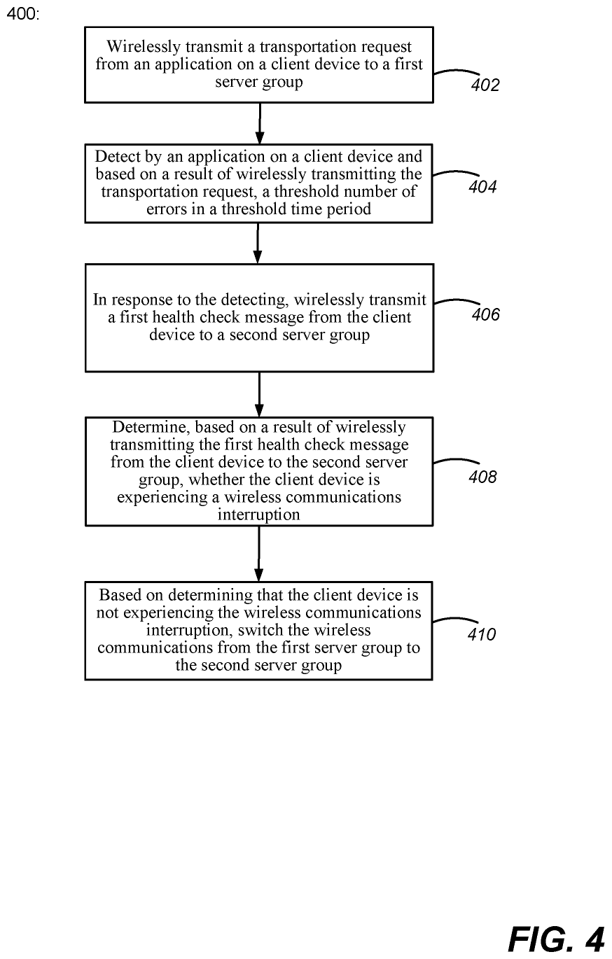

FIG. 4 illustrates one embodiment of an exemplary flow chart for automatically detecting whether the client device is experiencing wireless communication issues and switching communications from one server group to another server group, when necessary. At 402, a client device (e.g. client device 125) wirelessly transmits a transportation request from an application on a client device to a first server group. For example, the client device may generate (e.g. using a transportation application) a request for transportation or a response to a request for transportation. The client device may store the request in, for example, main memory 304 and processor 302 may copy the request to network interface device 320 to be sent through a network 326. Network 326 may be the same or similar network as network 115.

At 404, the client device detects, based on a result of wirelessly transmitting the transportation request, a threshold number of errors in a threshold time period. For example, processor 302 executing a transportation application may detect error information, a threshold number of errors in a threshold time period. At 406, the client device, in response to the detecting, wirelessly transmits a first health check message from the client device to a second server group. The client device may generate the health check using processor 302 and store the generated health check in main memory 304. The client device may transmit the health check using network interface device 320 to network 326.

At 408, the client device determines, based on a result of wirelessly transmitting the first health check message from the client device to the second server group, whether the client device is experiencing a wireless communications interruption. For example, the device may receive one or more responses to the health check via network interface device 320 and store the received information in main memory 304 and/or storage unit 316. The client device may, using processor 302, analyze the received information to determine whether the health check is successful or unsuccessful. At 410, the client device, based on determining that the client device is not experiencing the wireless communications interruption, switches the wireless communications from the first server group to the second server group. For example, the transportation application may update Internet addresses associated with the server from referencing the first server group to referencing the second server group. The update may occur in main memory 304 using process 302.

### Additional Configuration Considerations

Some advantages of the described approach include ability to quickly identify and track security breaches and display tracking results to enable a user to react to the breach. That is, received network data is mapped, aggregated, and transformed into tracking data that can be queried using a search engine for quick tracking results.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented hardware modules. The performance of certain operations may be distributed among one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

One or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application programming interfaces (APIs).)

The performance of certain operations may be distributed among one or more processors, not only residing within a single machine, but deployed across a number of machines. In some example embodiments, one or more processors or processor-implemented modules may be located in a single geographic location (e.g., within a home environment, an office environment, or a server farm). In other example embodiments, one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-contained sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for tracking malicious activity through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method of automatic failover handling, the method comprising:
sending, by a client device, to a primary server group, a service request of an application on the client device, wherein the client device has established wireless communications with the primary server group;
detecting, by the client device, a threshold number of errors within a threshold time period, wherein the errors are in response to the service request;
responsive to detecting the threshold number of errors in the threshold time period, sending, by the client device, a first health check message from the client device to a second server group, wherein the second server group is different from the first server group;
determining, by the client device, based on a result of sending the first health check message from the client device to the second server group, whether the client device is experiencing a wireless communications interruption; and
based on determining that the client device is not experiencing a wireless communications interruption, switching, by the client device, the wireless communications from the first server group to the second server group.

2. The computer-implemented method of claim 1, further comprising:
subsequent to switching the wireless communications to the second server group and while the second server group is available, sending, by the client device, to the first server group, a second health check message;
determining, by the client device, based on a result of sending the second health check to the first server group, whether the first server group is available; and
based on determining that the first server group is available, switching, by the client device, the wireless communications from the second server group to the first server group.

3. The computer-implemented method of claim 1, wherein determining whether the client device is experiencing the wireless communications interruption comprises:
determining, by the client device, after waiting a time out period, whether the client device has received, from the second group of servers, a response to the first health check message; and
based on determining that the client device has not received the response to the health check message from the second group of servers, determining, by the client device, that the client device is experiencing the wireless communications interruption.

4. The computer-implemented method of claim 1, wherein determining, by the client device, based on the result of sending the first health check message from the client device to the second server group, whether the client device is experiencing a wireless communications interruption, comprises:
receiving, by the client device, a response to the first health check message;
retrieving, by the client device, one or more response codes from the response to the first health check message; and
determining, by the client device, based on the one or more response codes, whether the client device is experiencing the wireless communications interruption.

5. The computer-implemented method of claim 1, wherein the client device comprises a failover handler at a networking stack of the client device, the service request comprises a domain name, and the failover handler rewrites the domain name before the service request is processed by the application layer.

6. The computer-implemented method of claim 1, wherein detecting, by the client device, the threshold number of errors within the threshold time period, is based on respective timestamps the detected errors.

7. The computer-implemented method of claim 1, wherein each of the first server group and the second server group comprises a failover priority, and the client device sends the first health check message based on the failover priorities of the first server group and the second server group.

8. A non-transitory computer-readable storage medium storing computer program instructions executable by one or more processors, the instructions comprising instructions to:
send, by a client device, to a primary server group, a service request of an application on the client device, wherein the client device has established wireless communications with the primary server group;
detect, by the client device, a threshold number of errors within a threshold time period, wherein the errors are in response to the service request;
responsive to detecting the threshold number of errors in the threshold time period, send, by the client device, a first health check message from the client device to a second server group, wherein the second server group is different from the first server group;
determine, by the client device, based on a result of sending the first health check message from the client device to the second server group, whether the client device is experiencing a wireless communications interruption; and
based on determining that the client device is not experiencing the wireless communications interruption, switch, by the client device, the wireless communications from the first server group to the second server group.

9. The non-transitory computer-readable storage medium of claim 8, the instructions further comprising instructions to:
subsequent to switching the wireless communications to the second server group and while the second server group is available, send, by the client device, to the first server group, a second health check message;
determine, by the client device, based on a result of sending the second health check to the first server group, whether the first server group is available; and
based on determining that the first server group is available, switch, by the client device, the wireless communications from the second server group to the first server group.

10. The non-transitory computer-readable storage medium of claim 8, wherein an instruction of the instructions to determine whether the client device is experiencing the wireless communications interruption comprises instructions to:
determine, by the client device, after waiting a time out period, whether the client device has received, from the second group of servers, a response to the first health check message; and
based on determining that the client device has not received the response to the health check message from the second group of servers, determine, by the client device, that the client device is experiencing the wireless communications interruption.

11. The non-transitory computer-readable storage medium of claim 8, wherein an instruction of the instructions to determine, by the client device, based on the result of sending the first health check message from the client device to the second server group, whether the client device is experiencing a wireless communications interruption, comprises instructions to:
receive, by the client device, a response to the first health check message;
retrieve, by the client device, one or more response codes from the response to the first health check message; and
determine, by the client device, based on the one or more response codes, whether the client device is experiencing the wireless communications interruption.

12. The non-transitory computer-readable storage medium of claim 8, wherein the client device comprises a failover handler at a networking stack of the client device, the service request comprises a domain name, and the failover handler rewrites the domain name before the service request is processed by the application layer.

13. The non-transitory computer-readable storage medium of claim 8, wherein detecting, by the client device, the threshold number of errors within the threshold time period, is based on respective timestamps the detected errors.

14. The non-transitory computer-readable storage medium of claim 8, wherein each of the first server group and the second server group comprises a failover priority, and the client device sends the first health check message based on the failover priorities of the first server group and the second server group.

15. A system, comprising:
one or more processors; and
a non-transitory computer-readable storage medium storing computer program instructions executable by the one or more processors, the instructions comprising instructions to:
send, by a client device, to a primary server group, a service request of an application on the client device, wherein the client device has established wireless communications with the primary server group;
detect, by the client device, a threshold number of errors within a threshold time period, wherein the errors are in response to the service request;
responsive to detecting the threshold number of errors in the threshold time period, send, by the client device, a first health check message from the client device to a second server group, wherein the second server group is different from the first server group;
determine, by the client device, based on a result of sending the first health check message from the client device to the second server group, whether the client device is experiencing a wireless communications interruption; and
based on determining that the client device is not experiencing the wireless communications interruption, switch, by the client device, the wireless communications from the first server group to the second server group.

16. The system of claim 15, the instructions further comprising instructions to:
subsequent to switching the wireless communications to the second server group and while the second server group is available, send, by the client device, to the first server group, a second health check message;
determine, by the client device, based on a result of sending the second health check to the first server group, whether the first server group is available; and
based on determining that the first server group is available, switch, by the client device, the wireless communications from the second server group to the first server group.

17. The system of claim 15, wherein an instruction of the instructions to determine whether the client device is experiencing the wireless communications interruption comprises instructions to:
determine, by the client device, after waiting a time out period, whether the client device has received, from the second group of servers, a response to the first health check message; and
based on determining that the client device has not received the response to the health check message from the second group of servers, determine, by the client device, that the client device is experiencing the wireless communications interruption.

18. The system of claim 15, wherein an instruction of the instructions to determine, by the client device, based on the result of sending the first health check message from the client device to the second server group, whether the client device is experiencing a wireless communications interruption, comprises instructions to:
receive, by the client device, a response to the first health check message;
retrieve, by the client device, one or more response codes from the response to the first health check message; and
determine, by the client device, based on the one or more response codes, whether the client device is experiencing the wireless communications interruption.

19. The system of claim 15, wherein the client device comprises a failover handler at a networking stack of the client device, the service request comprises a domain name, and the failover handler rewrites the domain name before the service request is processed by the application layer.

20. The system of claim 15, wherein detecting, by the client device, the threshold number of errors within the threshold time period, is based on respective timestamps the detected errors.
